(19) United States
(12) Patent Application Publication
(10) Pub. No.: US 2011/0254967 A1
(43) Pub. Date: Oct. 20, 2011

(54) VIRTUAL LIBRARY CAPTURE AND RETRIEVAL SYSTEM FOR AUDIO, FILM AND VIDEO ELEMENTS

(75) Inventor: Charles M. Filliettaz III, Burbank, CA (US)

(73) Assignee: POST PRO FINANCE, INC., Burbank, CA (US)

(21) Appl. No.: 12/837,388

(22) Filed: Jul. 15, 2010

Related U.S. Application Data
(60) Provisional application No. 61/324,682, filed on Apr. 15, 2010.

(51) Int. Cl. H04N 5/225

(52) U.S. Cl. 348/207.11; 348/E05.042

(57) ABSTRACT

The invention includes a image capture subsystem, a computing device and a software program. The software program is stored on the computing device. When executed, the image capture subsystem captures images of different faces or sides of the physical element, crops and resizes the images to map to a selected physical model and then creates a virtual representation of the physical element based on the selected physical model. These element virtual representations are stored in a database along with indexing information. Each of the images may also be scanned and metadata regarding the physical elements is captured and indexed. The software system and program, which when executed, also allows owners/user to input element identification information to retrieve relevant element virtual representations. After the element virtual representation has been retrieved, an owner or user can review and sort, from their computer device, without ever physically touching or retrieving from storage the physical element. Users can organize, sort, and store these elements in lower cost environments.

### BACKGROUND OF THE INVENTION

In the entertainment industry, there is an enormous amount of archival footage for old albums, old television programs, old feature films and old commercials. In many instances, producers, executives, directors and editors desire to utilize or review the archival footage for a new project or to port an old program or audio tape to a new medium, e.g., blue ray disk or digital audio tape. For example, the archival footage is stored on audio tapes, video tapes, video cassettes, reel-to-reel tapes, etc, which may be referred to as physical elements.

Presently, hundreds of thousands of audio, film & tape physical elements are stored in expensive, temperature controlled, above-ground facilities that are located close to their owners because these elements may need to be inspected and reviewed at any time. For example, there are large above-ground facilities located in Los Angeles or the surrounding suburbs in order to allow for quick and easy access to the archival footage.

The cost of housing the audio, film and tape physical elements is extremely expensive due to the high real estate costs and HVAC cost associated with locating the storage facilities near the film studios or other production studios. The physical elements also need to be stored in a temperature controlled environment, which necessitates the HVAC cost. In addition, there is no way to inspect the physical element and the contents of the physical elements unless the actual physical audio, film or tape element is pulled from storage and viewed. Accordingly, a cost-effective system is needed to allow storage facilities to be moved to lower cost geographic locations and to also allow for easy review of the physical elements by parties that desire to use archival footage.

### BRIEF DESCRIPTION OF THE DRAWINGS

FIG. 1(a) is a flowchart illustrating operation of a virtual vault capture and index system according to an embodiment of the invention;

FIG. 1(b) is a flowchart illustrating operation of a virtual vault retrieval system according to an embodiment of the invention;

FIG. 2 is a flowchart illustrating operation of an automatic virtual vault capture system according to an embodiment of the invention;

FIGS. 3a, 3b and 3c illustrate element virtual representations according to an embodiment of the invention;

FIGS. 4a and 4b illustrates an image capture system according to an embodiment of the invention;

FIGS. 5a-5d illustrate an image capture subsystem according to an embodiment of the invention;

FIG. 6 is a flowchart illustrating operation of a virtual library capture and index system according to an embodiment of the invention;

FIG. 7a-7g illustrate images of six faces of a representative physical element along with an interior of the physical element according to an embodiment of the invention; and

FIG. 8 is a flowchart illustrating operation of a virtual library retrieval system according to an embodiment of the invention;

### DETAILED DESCRIPTION OF THE INVENTION

All of the audio, film, & video elements are either stored in, or are themselves, a three dimensional polyhedron (e.g., cube/cylinder) of varying dimensions. Each side of the object usually contains alphanumeric label information and/or identification markings/symbols such as barcodes. Each of the six sides is captured in a high resolution two dimensional image. All six of these images are “mapped” onto a three dimensional virtual representation of that object in a computer/website to be manipulated and inspected in three dimensional proxy. Before the mages are mapped, each of the images may be cropped or resized to fit the three dimensional polyhedron. The images will be high enough resolution so that text and other metadata on the object faces can be automatically extracted (OCR). A seventh image of the inside of the container (usually a tape label) is captured as well. This three dimensional representation, as well as the two dimensional images will be combined in a computer/website database with other index metadata from existing databases to give the user complete index-able/searchable information on the element. Later, metadata from the element can be captured/digitized from the element and combined in the same database, so the user can actually see what is on the audio, tape or film element. This includes labels as well as text on the labels as well as other markings on the physical elements.

Image Capture—In an embodiment of the invention, six camera/scanners are set around a glass table-top with their focal planes parallel to the image plane of the element/polyhedron. Images are captured simultaneously or in rapid succession, named with appropriate angle prefixes and unique identifier (index/barcode) and stored in computer memory. The element container is manually opened and a seventh image/scan of the interior is captured in the same manner above. The images may be transferred to a computer system which has the virtual library capture, index and retrieval software stored thereon. The images may be transferred via a wired or wireless connection or may be stored on a portable storage device, which then is inserted into or placed in proximity with the computer system housing the virtual library software. Any communication protocol may be utilized. Images will be captured using one or more of the following technologies:
Color
Black & White
Infrared
Still
Video
Webcam
High Definition
Standard Definition

Image Storage—Images will be stored in their native format, un-cropped in the indexing database with a common index number (barcode) and corresponding file naming conventions above. Formats that can be used are:
JPEG
TIFF
RAW
PDF

Image Display—Scale dimensions for each type of polyhedron (cube) are taken and programmed, them manually selected for each element captured. The appropriate image cropping is applied to the corresponding element and the resulting images are “mapped” onto a three dimensional representation of the object allowing the user to turn, flip, and zoom into each object face. A mouse or keyboard button “opens” the element container—allows the user to see the seventh image of the interior of the container described above.

Metadata Extraction—Each image captured from the processes above is automatically scanned using OCR or a similar process. Characters, numbers, symbols and alphanumeric strings are extracted from the photographic image. In addition, there may be handwritten comments or notes on the element label. The handwritten comments or notes may also be extracted from the photographic image. The resulting metadata is combined and stored for future indexing/searching within the index database. The resulting metadata may be stored in a plurality of fields in the index database. These fields may include, but are not limited to: 1) name of organization that has physical possession of the element; 2) generation date; 3) company/studio who owns the physical element; 4) title of element; 5) version of element; 6) type of element; 7) description of the element; 8) TRT; 9) element format; 10) frame rate; 11) aspect ratio; 12) captioning information; 13) subtitles; 14) audio configuration; 15) a creation date; and 16) outside barcode information. Because the image is scanned to extract metadata, all or a large portion of the metadata is extracted from the photographic image and stored for future indexing/searching. In alternative embodiments of the invention, metadata may be input to the virtual library system through batch input or manual entry.

Automation & Scripting—This process uses several existing technologies/programs to capture, crop, transcode, store, and display images. Coordinating scripts are used to tie these multiple processes together. Future physical automation (such as conveyer technology) and synced auto-capture will speed up this process as well. Although this virtual library capture and retrieval system and process is intended for media elements such as audio, film, and video, the system and process may be applied to just about any polyhedral object at any scale.

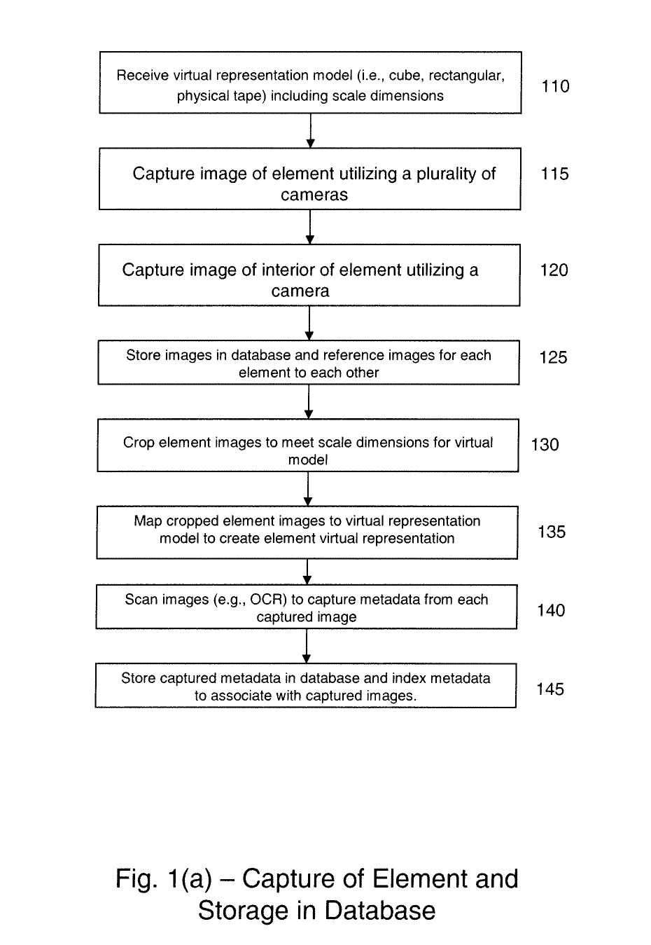

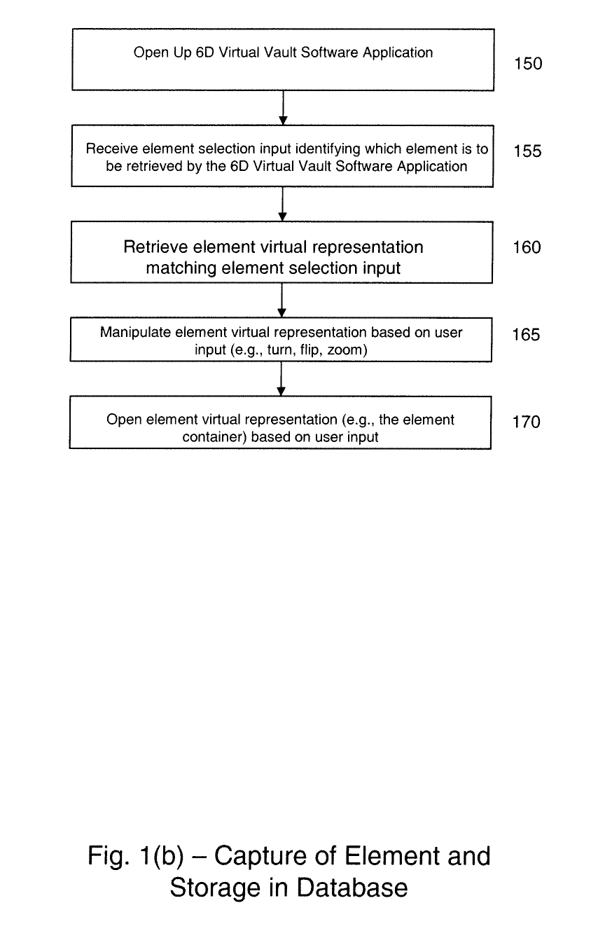

FIG. 1(a) is a flowchart illustrating operation of a virtual vault capture and index system according to an embodiment of the invention. In an embodiment of the invention, a virtual representation model is selected. The virtual vault system receives 110 the virtual representation model (e.g., a cube, rectangle, physical tape, etc.) including scale dimensions of the virtual representation model. In an embodiment of the invention, the capture system for the virtual vault system includes six cameras. The physical element (e.g., tape, CD, mini-tape, newsreel, reel-to-reel tape, etc.) may be placed onto a surface (e.g., a transparent table or a glass table) in order for the capture system to capture an image of different sides of the physical element. The virtual vault capture system captures 120 images of the physical element utilizing a plurality of cameras. Illustratively, there may be six cameras (top, bottom, front, back, right hand side and left hand side). The virtual vault capture system captures an image of a surface with each of the cameras (e.g., six images if six cameras are utilized). In an embodiment of the invention, the virtual vault capture system may also capture an image of an interior of the physical element. The physical element may be opened to reveal an interior and a camera (which is part of the image capture system) may capture an interior of the physical element. Under certain operating conditions, the top camera may capture 120 the interior of the physical element. The virtual vault system then stores 125 the captured images into a database. The virtual vault system also creates indexes or links to reference all of the images for one physical element to each other because the plurality of images are related to one physical element. In an embodiment of the invention, the virtual vault system also crops or resizes 130 the physical element images to meet scale dimensions for the virtual representation model. The virtual vault system maps 135 the adjusted element images to the virtual representation model to create an element virtual representation. The virtual vault system scans 140 images to capture metadata from each captured image. The scanning may be OCR scanning or other metadata capture scanning methods. Illustratively, the virtual vault system may scan seven images if seven images are captured. The metadata, as is discussed above, may be characters, numbers, symbols and alphanumeric strings. The virtual vault system may store 145 the captured metadata for each of the captured images in the database. The virtual vault system may also index the metadata to associate the metadata with the captured images for the physical element or to associate the metadata with the corresponding element virtual representation.

FIG. 1(b) is a flowchart illustrating operation of a virtual vault retrieval system according to an embodiment of the invention. After capture of all of the physical elements and the creation of a plurality of element virtual representations for the physical elements such as a tape, CD, audio tape, Laserdisk, etc., the database may include a large number of element virtual representations. The virtual vault software application may be opened 150. The virtual vault software application may receive 155 element selection input identifying an element virtual representation that is to be retrieved by the virtual vault retrieval software. For example, the virtual vault retrieval software may receive a request to locate the element virtual representation for a videotape from December of 2009 including footage of a train accident or the request may be for the original movie reel footage of a title that a studio is about to convert to 3-D. The virtual vault retrieval software may then retrieve 160 the element virtual representation that matches (or is most closely aligned with) the element selection input and then the virtual vault retrieval software may display the selected or retrieved element virtual representation. In certain operating environments, the virtual vault retrieval software may also present a number of element virtual representations that most closely are aligned with the element selection input (for example, if no exact match is found). The virtual vault retrieval system may receive input from a user to manipulate the selected element virtual representation and may display 165 the element based on the requested manipulation. Illustratively, the virtual vault retrieval system may turn, flip, zoom or rotate the selected element virtual representation. Under certain operating conditions, the virtual vault retrieval system may receive input to display the interior of the element virtual representation and the virtual vault retrieval system may open 170 the element virtual representation based on the input. The user may then view an interior image of the selected element virtual representation.

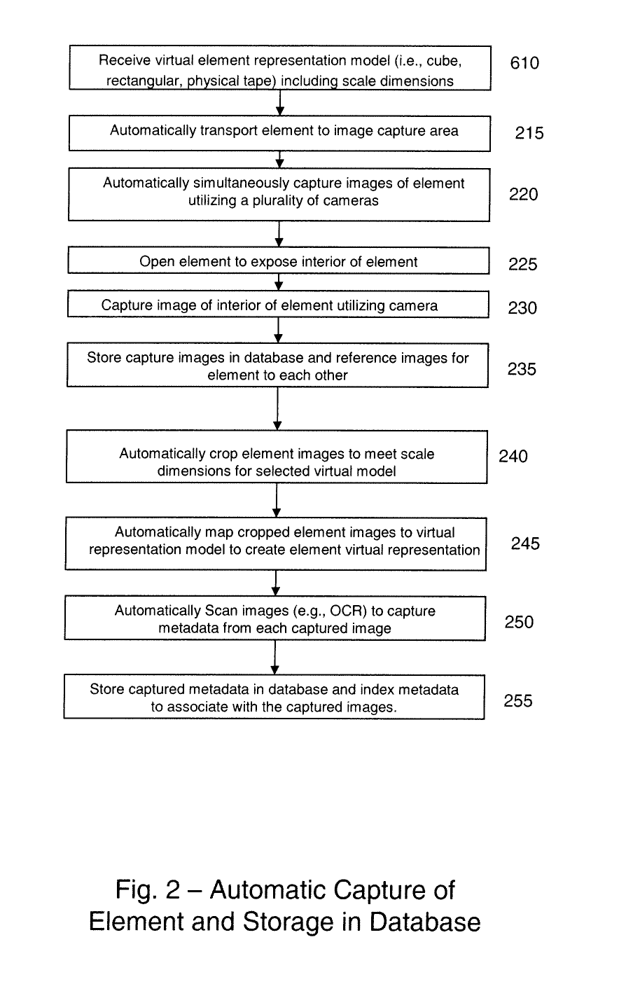

FIG. 2 is a flowchart illustrating operation of an automatic virtual vault capture system according to an embodiment of the invention. In an embodiment of the invention, a virtual representation model is selected. The virtual vault system receives 210 the virtual representation model (e.g., a cube, rectangle, physical tape, etc.) including scale dimensions of the virtual representation model. In an embodiment of the invention, the capture system for the virtual vault system includes six cameras. The capture system of the virtual vault system may also include less or more cameras depending on the size and shape of the physical element. In this embodiment of the invention, the physical element may be automatically transported 215 to the image capture area. Illustratively, a conveyor belt may be utilized to transport the physical element to the image capture area. In an embodiment of the invention, the conveyor may be made of a transparent material in order to allow capture of a bottom side of the physical element. The automated image capture system of the virtual vault system may automatically capture 220 images of the element utilizing the plurality of cameras. In an embodiment of the invention, the plurality of images may be captured simultaneously. In an embodiment of the invention, the physical element may need to be repositioned via a robotic device in order to capture different surfaces of the physical element. In this case, all images of the different faces of the physical element may not be captured simultaneously. In an embodiment of the invention, the physical element may be opened 225. The physical element may be opened manually. The physical element may be opened automatically (e.g., via a robotic system). In an embodiment of the invention, an image capture system of the virtual vault system image may capture 230 an image of the interior of the physical element.

The virtual vault system then automatically stores 235 the captured images into a database. The virtual vault system also creates indexes or links to reference all of the images for one physical element to each other because the plurality of images are related to one physical element. In an embodiment of the invention, the virtual vault system also automatically crops or resizes 240 element images to meet scale dimensions for the virtual representation model. The virtual vault system automatically maps 245 the adjusted element images to the virtual representation model to create an element virtual representation. The virtual vault system automatically scans 250 images to capture metadata from each captured image. The scanning may be OCR scanning or other metadata capture scanning methods. Illustratively, the virtual vault system may scan seven images if seven images are captured. The metadata, as is discussed above, may be characters, numbers, symbols and alphanumeric strings. The virtual vault system may store 255 the captured metadata for each of the captured images in the database. The virtual vault system may also index the metadata to associate the metadata with the captured images for the physical element or to associate the metadata with the corresponding element virtual representation.

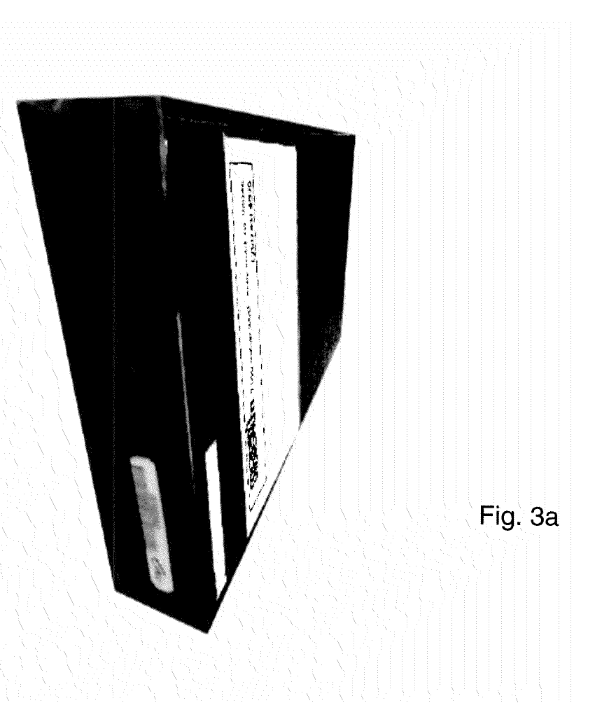

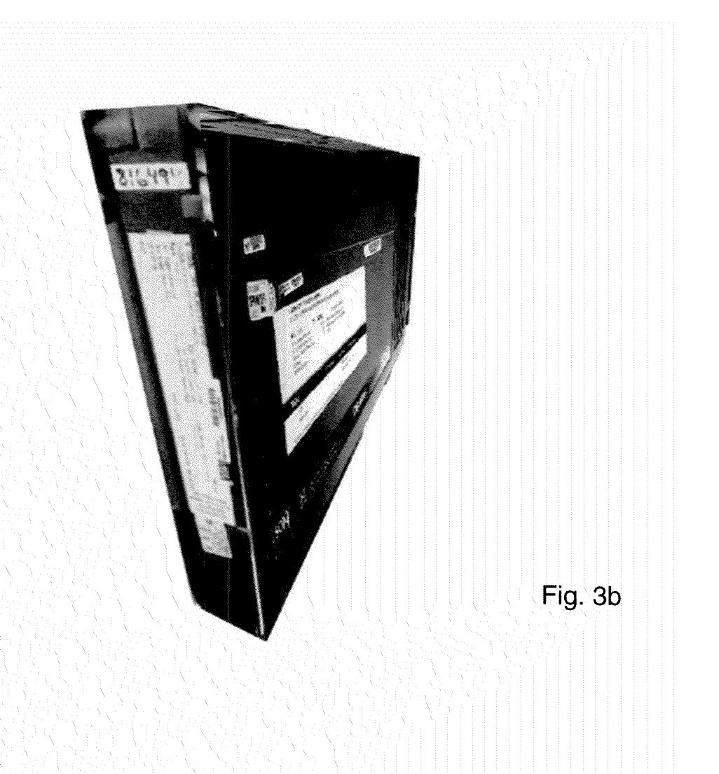

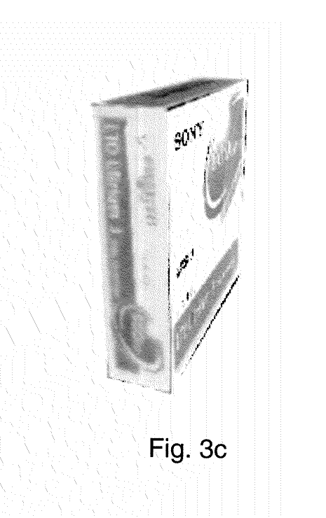

FIGS. 3a, 3b and 3c illustrate element virtual representations according to an embodiment of the invention. These are only illustrative examples and additional virtual representations may be created. As is illustrated in FIG. 3a, the physical element was a ¾″ Umatic tape and the element virtual representation shows the virtual representation of the Umatic tape. In FIG. 3b, the physical element is a D2 Wide Load Master and the element virtual representation shows the virtual representation of the Wide Load Master. In FIG. 3c, the physical element is a LTO4 cassette and the element virtual representation shows the virtual representation of the cassette.

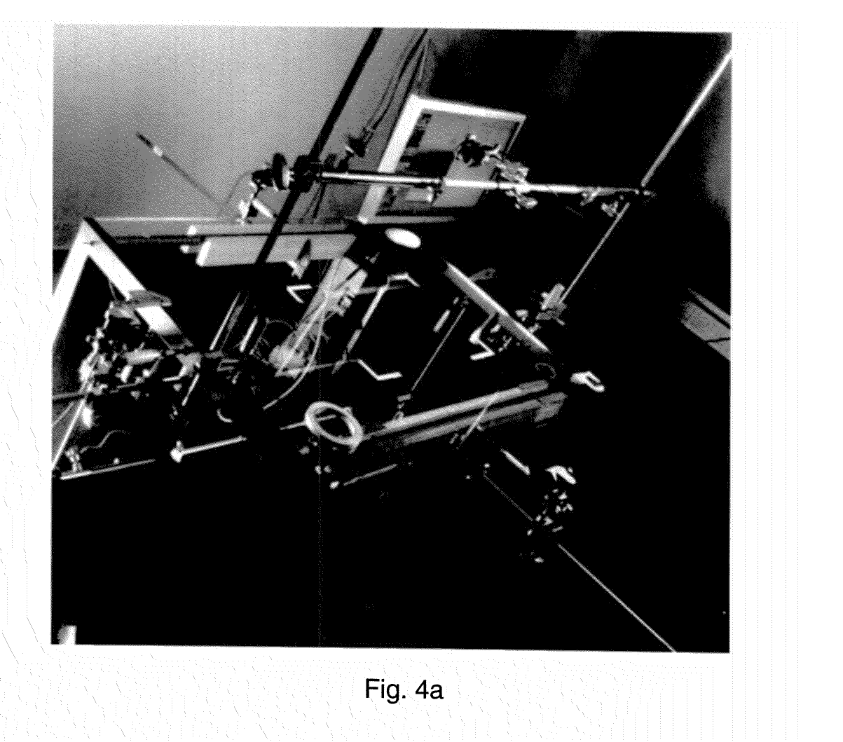

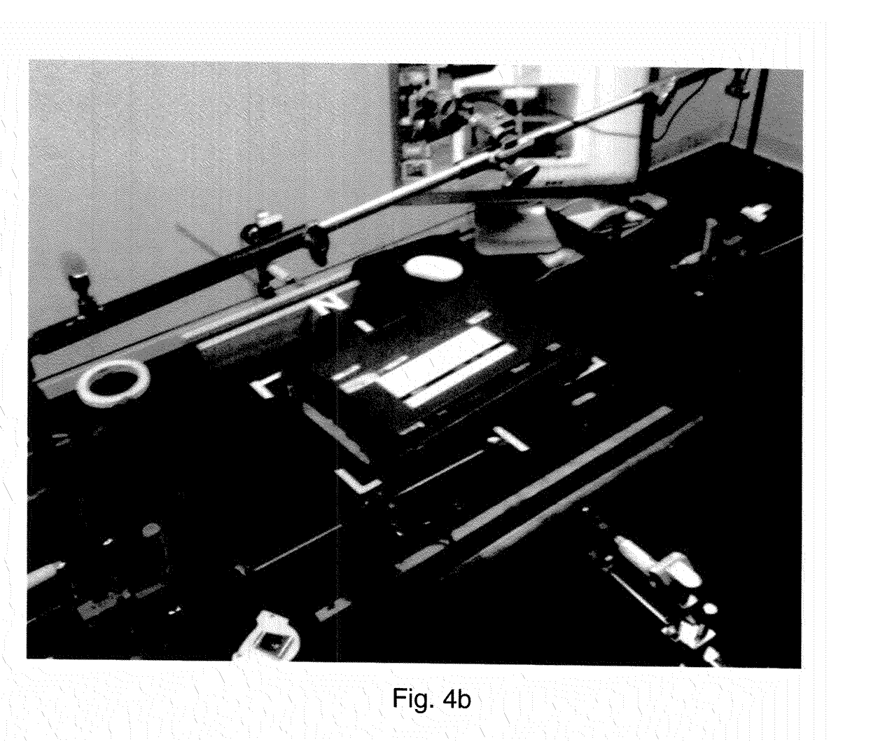

FIGS. 4a and 4b illustrates an image capture system according to an embodiment of the invention. In this embodiment of the invention, the image capture system includes six cameras (top, bottom, front, back, right side and left side) and the physical element is placed on a transparent glass surface. The cameras are coupled or connected to the transparent glass surface. A computer which includes the virtual vault system software is also illustrated. In FIG. 4b, a physical element is displayed on the glass surface.

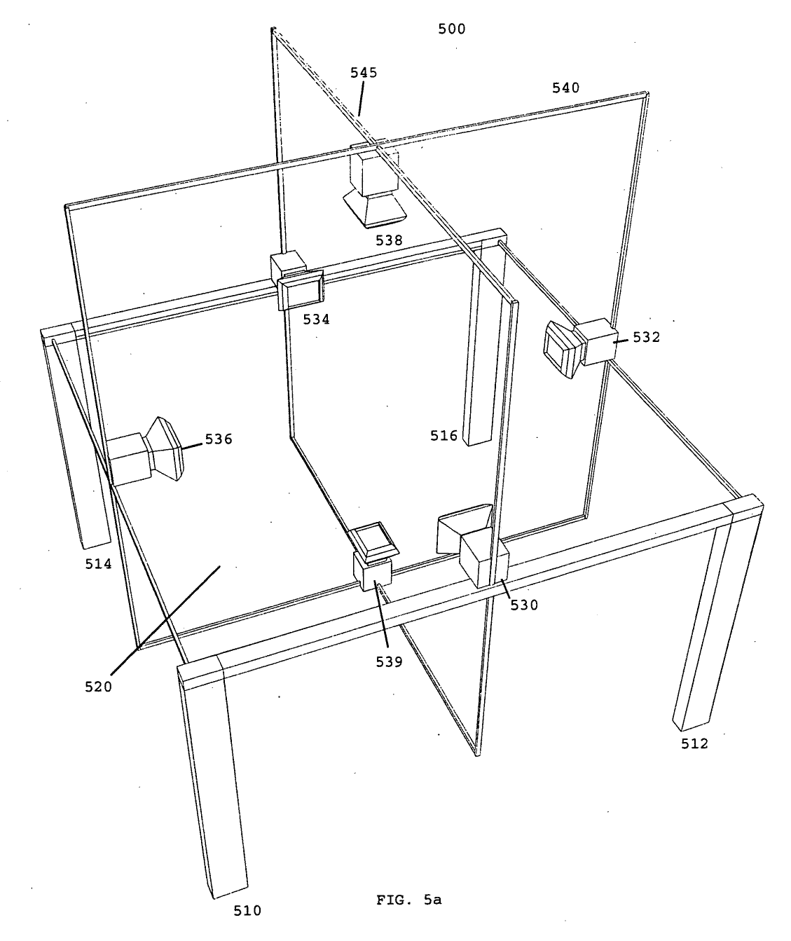

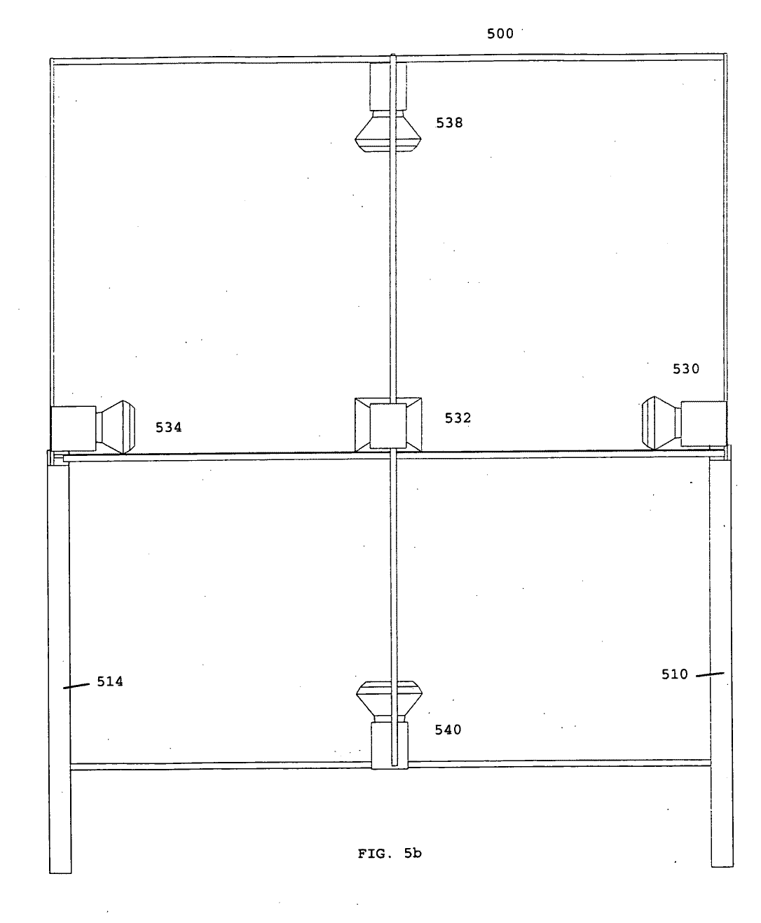

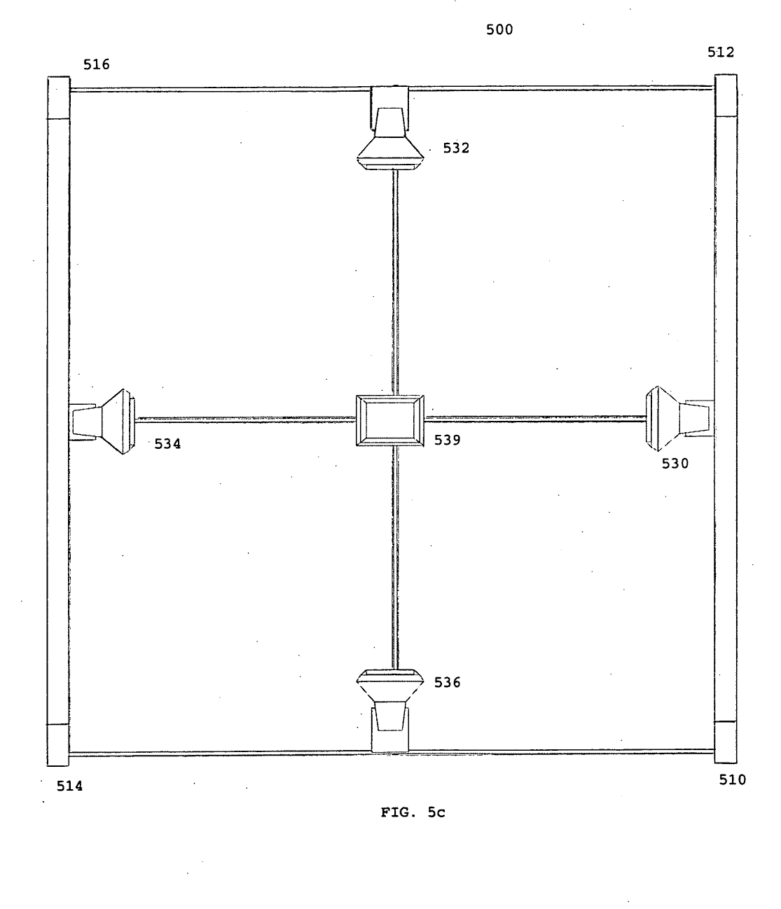

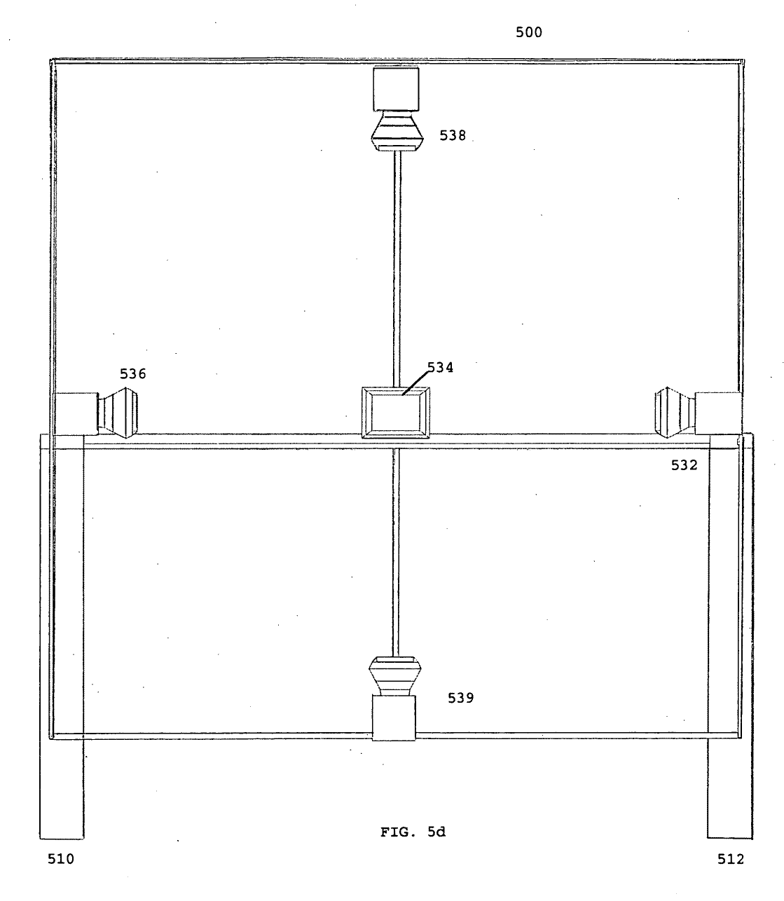

FIG. 5a illustrates a top perspective view of an image capture subsystem according to an embodiment of the invention. FIG. 5b illustrates a side view of an image capture subsystem according to an embodiment of the invention. FIG. 5c illustrates a top perspective view of an image capture subsystem according to an embodiment of the invention. FIG. 5d illustrates a front view of an image capture subsystem according to an embodiment of the invention. In FIG. 5a, six imaging devices are utilized to capture images of the physical element. The image capture system includes support legs 510, 512, 514 and 516, a transparent surface 520, six imaging devices 530, 532, 534, 536, 538 and 539, and capture positioning devices 540 and 545. In an embodiment of the invention, a top capture device 538 and a bottom capture device 539 are placed above and below, respectively, a same point of transparent surface. A transparent surface is utilized in order for a bottom capture device to capture a bottom image of the physical element. In the embodiment of the invention, the capture positioning devices 540 and 545 each assist in positioning four image capture devices. For example, capture positioning device 540 assists in positioning image capture devices 532, 534, 538 and 539, while capture positioning device 545 assists in positioning capture devices 530, 539, 538 and 534. The capture devices may be positioned utilizing a variety of methods, including having each capture device individually positionable, via, for example, a clamping device.

In an embodiment of the invention, the image capture system may include an external light source (e.g., a lamp, a spotlight). The external light source may be placed above the physical object, below the physical object or to a side of the physical object in order to enhance visibility of the physical object. The external light source may be a lamp, a light bulb, LEDs, a spot light.

The image capture system 500 may include a draping material. The image capture system 500 may include a covering material. The draping material may cover a portion of the image capture system in order to provide improved illumination characteristics for the physical element being captured. In an embodiment of the invention, the draping material may be located over a space covering a portion of the image capture system (e.g., a back half or a front third). In another embodiment of the invention, the draping material may cover all of the space of the image capture subsystem so that no outside illumination is utilized during image capture.

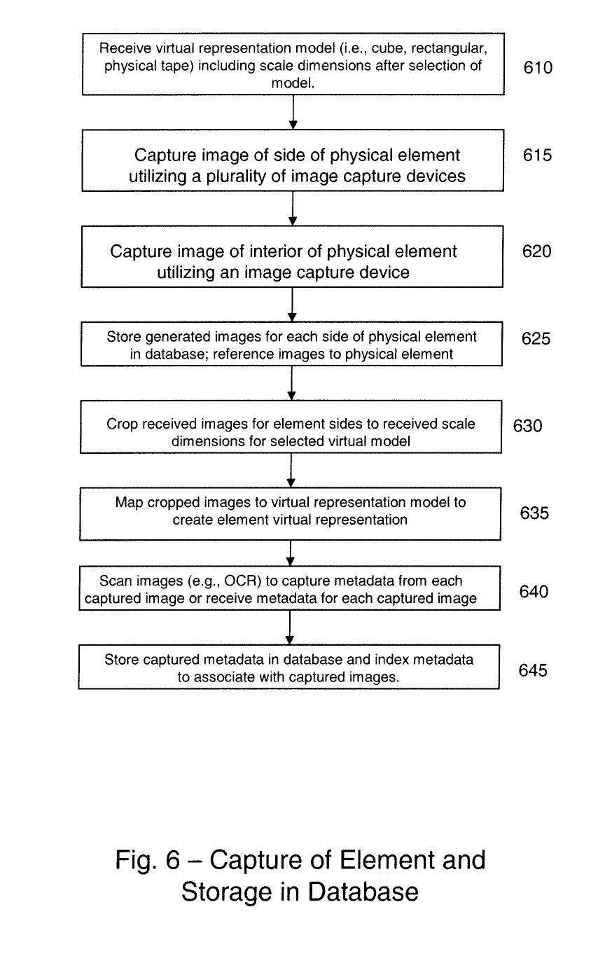

FIG. 6 is a flowchart illustrating operation of a virtual library capture and index system according to an embodiment of the invention. In an embodiment of the invention, a virtual representation model is selected. The virtual representation model may be a cube, a rectangle, a circular casing, or another three-dimensional shape. The virtual representation model may be selected depending upon the shape of the original physical element. The virtual selected model may have a number of scale dimensions. For example, the physical element may be a D5, which has dimensions of 12.5 inches,×7.5 inches×1.5 inches. The HDCAM SR has dimensions of 10.75 inches×6.5 inches×1.6 inches and the D1 has dimensions of 11 inches×16.75 inches×2 inches. The virtual library system receives 610 the virtual representation model including scale dimensions of the virtual representation model.

In an embodiment of the invention, the capture system for the virtual library system includes six image capture devices. The image capture devices may be digital cameras. The digital cameras may have a specific focal length. The image capture devices do not bend the images at the edge of the images. The image capture devices may be in fixed positions. Specifically, for each type of physical element being capture, the plurality of image capture devices remain in fixed positions. If a different physical element is utilized, the plurality of image capture devices may be moved to different fixed positions in order to capture the highest quality images of the different physical element.

The physical element (e.g., tape, CD, mini-tape, newsreel, etc.) may be placed onto a surface of the image capture system. The surface may be a top of a transparent table or a glass table. If the surface is transparent or clear, a bottom image capture device may capture a bottom side of the physical element. The surface may be made of a material that minimizes reflection when the image capture devices are capturing the image. For example, the surface may be a clear plastic. In an embodiment of the invention, the surface may be plexiglass or a similar material.

The virtual library capture system captures 620 images of the physical element utilizing the plurality of image capture devices (e.g., cameras). In an embodiment of the invention, such as the embodiment illustrated in FIG. 5a, virtual vault capture system may include six image capture devices (a top image capture device, a bottom image capture device, a front image capture device, a rear image capture device, a right side image capture device and a left side image capture device). A software package such as Security Spy may be utilized to capture images of the faces of the physical element. Alternatively, other image capture software programs may capture images of sizes of the physical element. The images may be transmitted to a computer system having the virtual library capture and indexing software stored thereon via a wired or wireless connection via any one of a number of communication protocols.

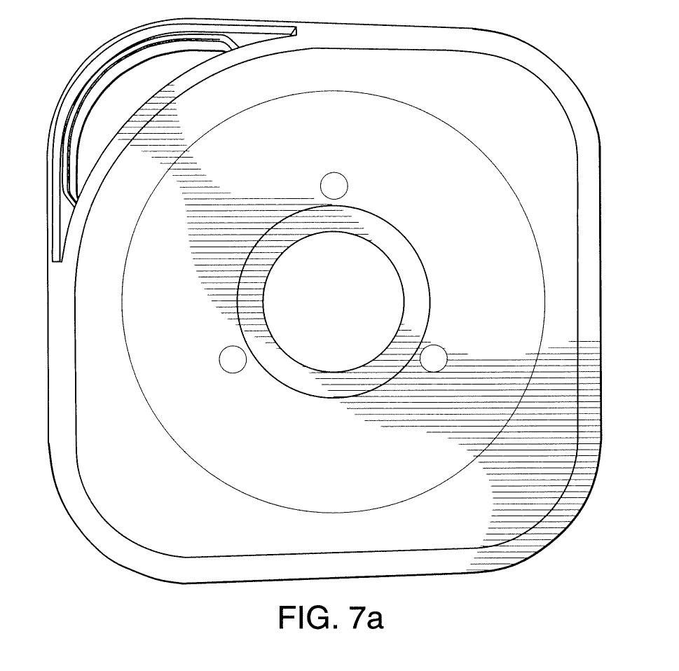

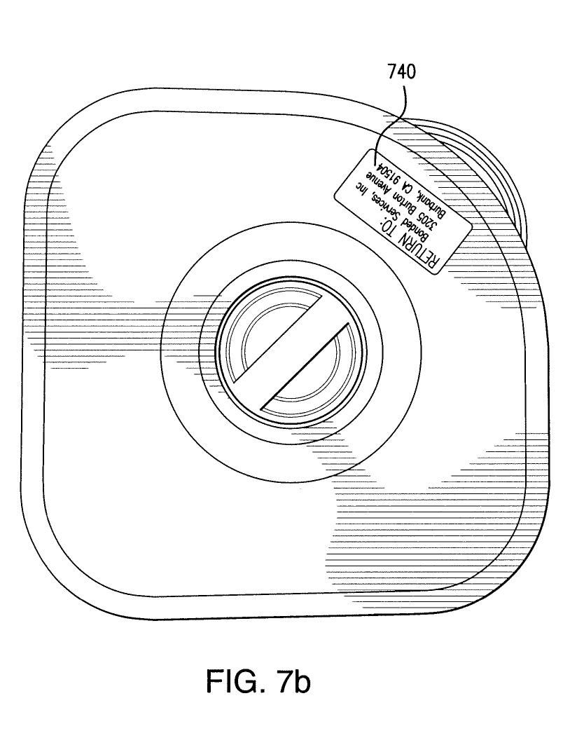

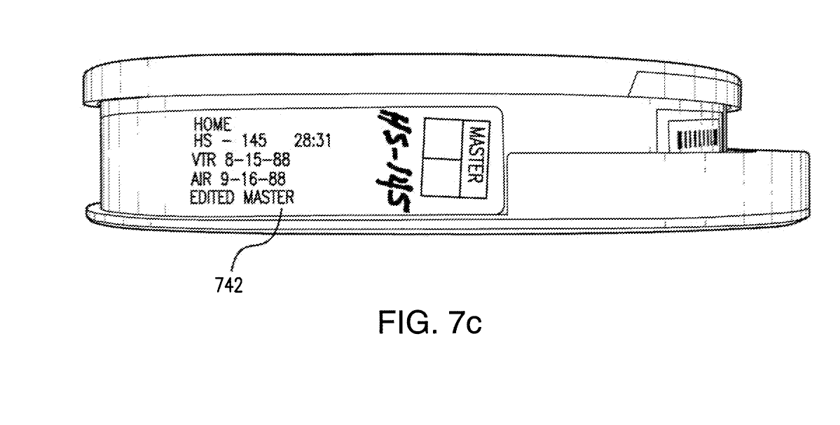

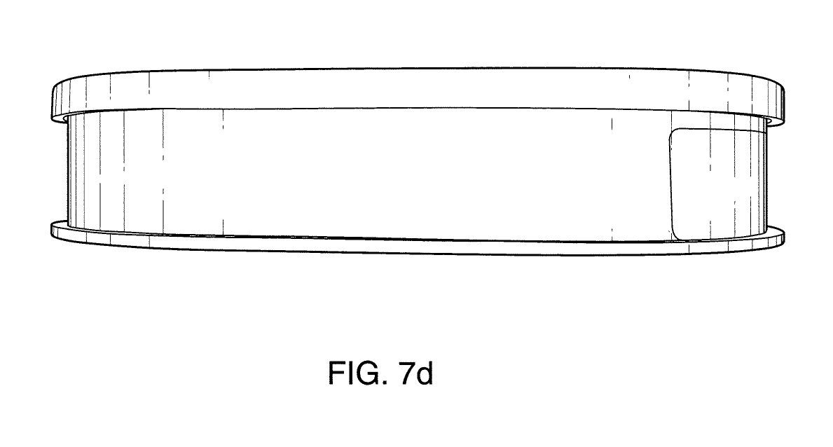

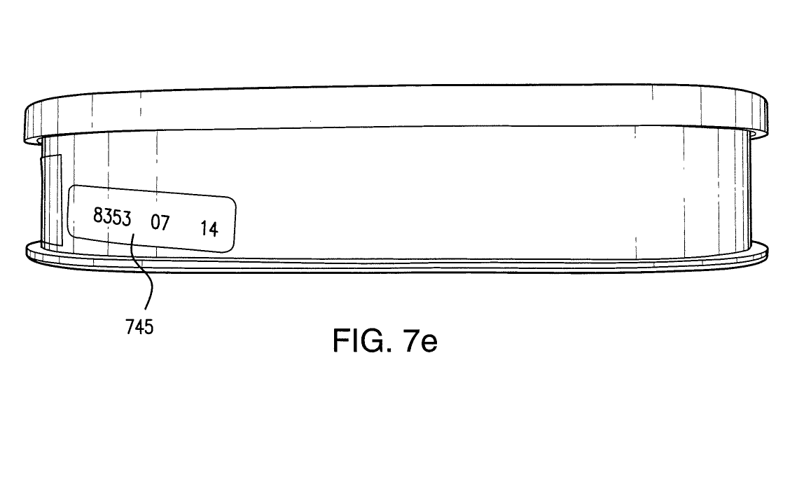

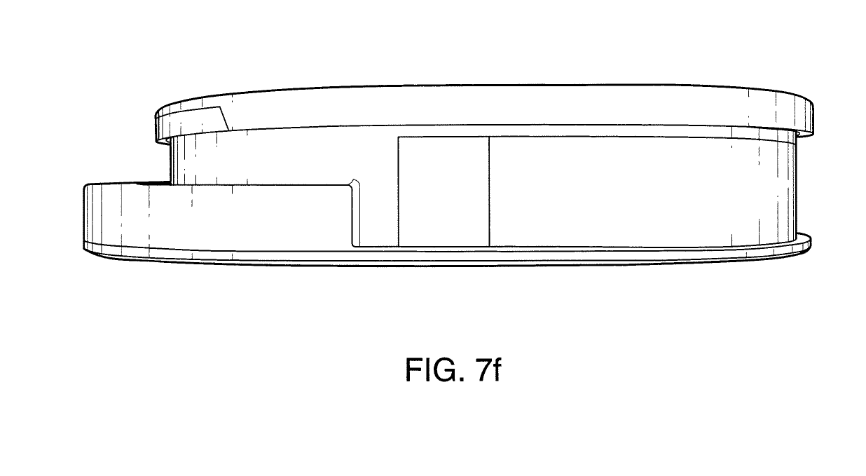

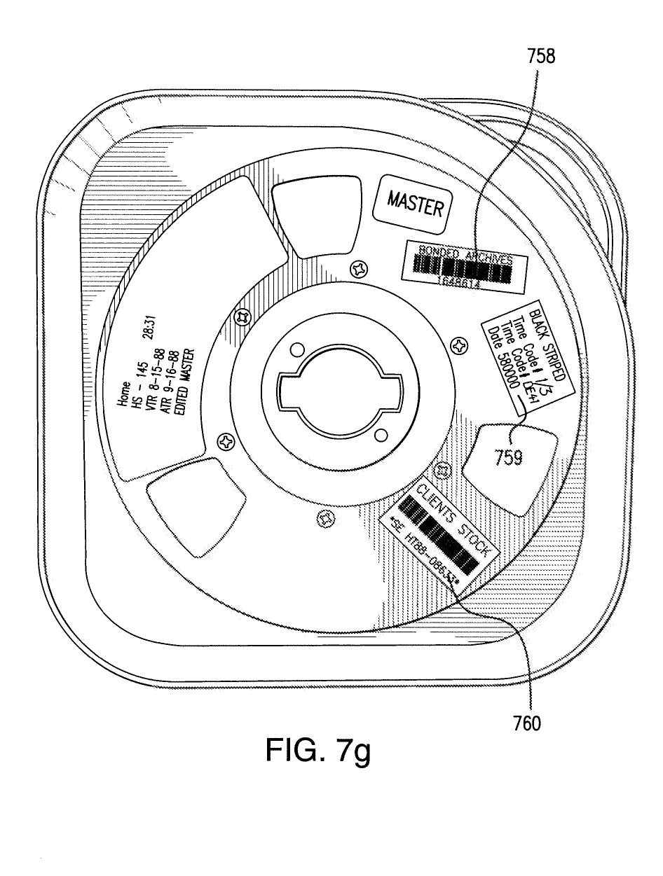

The capture devices in the virtual library capture system capture an image of a side of the physical element. Under certain operating conditions, each side has a corresponding image capture device. FIG. 7a-7g illustrate images of six faces of a representative physical element along with an interior of the physical element. Reference number 740 includes a return address label, reference number 742 include element information, reference number 745 includes a stock lot number, reference numbers 758 and 760 include tracking barcodes and reference number 759 includes a black and coding sticker.

In an embodiment of the invention, the virtual library capture system may also capture an image of an interior of the physical element using one of the existing image capture devices. The physical element may be opened to reveal an interior and one of the image capture devices may capture an interior of the physical element. Under certain operating conditions, the top image capture device may capture 620 the interior of the physical element. Illustratively, an image of the interior of the physical element may include an image of the actual physical videotape or audiotape. For example, a tape may have an additional label which includes tape content information. FIG. 7g illustrates an image of the interior of the physical element according to an embodiment of the invention.

In an embodiment of the invention, the images of the sides of the physical element are captured simultaneously (e.g., all six at the same time). In an embodiment of the invention, the image capture system may create six image files or seven image files (if the interior of the physical element is captured). The image file may be in a .jpeg or .mpeg format. The images of the sides of the physical element may also be captured sequentially. The image files are date stamped. Under certain operating conditions, all image files corresponding to the same physical element may have a similar prefix or name

The virtual library system stores 625 the captured images into a database. The virtual library system may store the images in a temporary buffer before the images are stored in the database. The virtual library system also creates indexes or links to reference all of the images for one physical element to each other to identify that the plurality of images are related to one physical element.

In an embodiment of the invention, the virtual library system also crops or resizes 630 the images of the faces of the physical element to meet scale dimensions for the virtual representation model. In an embodiment of the invention, the pixel values are not modified or changed, instead the captured images are cropped to the scale dimensions of the virtual selected model. The virtual library system does not modify pixel values and only scales the dimensions of the image to meet the scale dimensions of the selected virtual representation model.

Illustratively, a captured image of the front face of the physical element may be cropped to represent the dimensions of the front face of the selected virtual representation model, e.g., 2 inches by 4 inches. Each of the captured images are cropped or resized to meet the scale dimensions of the corresponding faces of the virtual representation model. These images are referred to as the adjusted element images.

The virtual library system then maps 635 the adjusted images (the images of the physical elements after the images have been cropped and/or resized) to the virtual representation model to create an element virtual representation. In an embodiment of the invention, the element virtual representation may be stored as one or more image. The element virtual representation appears on the display of the virtual library system as a three-dimensional image. The virtual library system also creates an index for the virtual representation model. In an embodiment of the invention, the element virtual representation is a single three-dimensional image. The original six or seven images, corresponding to sides of the physical element (and an interior thereof), are also maintained in the virtual library system.

In an embodiment of the invention, the virtual library system scans 640 the captured images of the sides of the physical element to acquire metadata from each of the captured images. Although this is listed after the mapping of the captured images, the scanning of the captured images may occur before the images are mapped to the selected virtual representation model. The scanning may utilize Optical Character Recognition or other metadata capture scanning methods in order to capture text or handwriting that is present on the container or labels of the physical element (and thus the captured image of the face of the physical element). The scanning done by the virtual library system may also capture object, i.e., the scanning software may include object recognition software. Illustratively, under certain operating conditions, the virtual library system may scan seven images. The virtual library system may acquire metadata for the seven images if seven images are captured for the physical element. In an embodiment of the invention, the metadata corresponding to the physical element may be input into the virtual vault system via a batch method or via data entry.

The metadata, as is discussed above, may be characters, numbers, symbols and alphanumeric strings. The metadata is important because the metadata is pieces of information that can trigger a requester's memory of the exact content that is stored on the media stored within the visual element. For example, the metadata could indicate “Beach Scenes, Season 4, Episodes 5-8, Baywatch” for a film or a tape or “Master Tracks, U2—Rattle and Hum” for an audio tape.

The virtual library system may store 645 the captured metadata for each of the captured images of the faces of the physical element in the database. The virtual library system may also index the metadata to associate the metadata with the captured images for the physical element or to associate the metadata with the corresponding element virtual representation. In an embodiment of the invention, a database record or may be created for each created virtual physical element and all of the metadata for the created virtual element may be stored within the database record. For example, the database record for a video tape may include a link to the element virtual representation, a link to each of the original images corresponding to faces of the physical element, and metadata corresponding to each of the original images of the faces of the physical element. The metadata is placed in searchable fields in the database so that the virtual library retrieval system may utilize the fields to search for all element virtual representations (and thus physical elements) that meet a specified criteria, e.g., beach pier scenes.

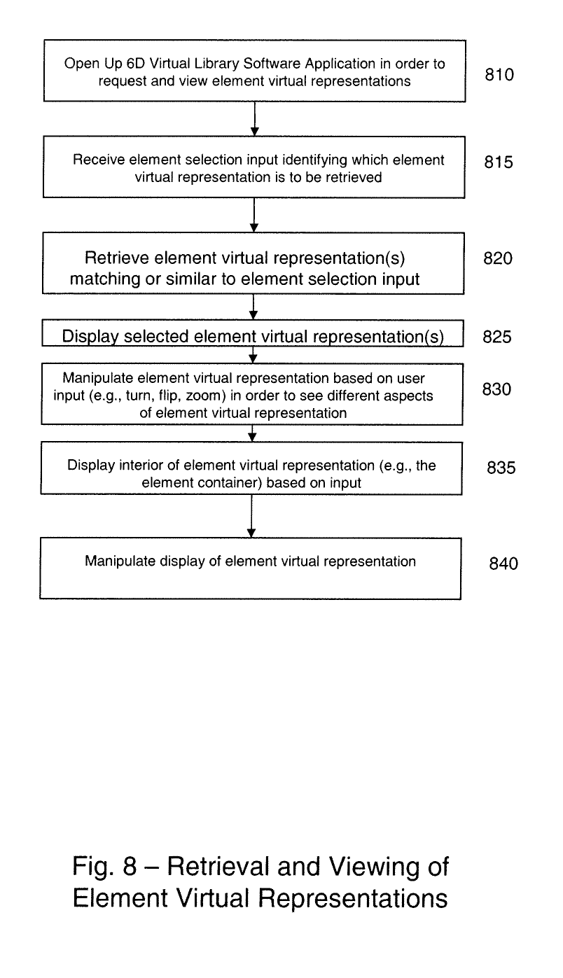

FIG. 8 is a flowchart illustrating operation of a virtual library retrieval system according to an embodiment of the invention. After capture of all of the physical elements and the creation of a plurality of element virtual representations for the physical elements such as a tape, CD, audio tape, video tape, etc., the database may include a large number of element virtual representations. In an embodiment of the invention, each element virtual representation includes a database record having searchable fields. In an embodiment of the invention, the database record may include the following information.

2G Barcode

Generation

Company

Title

Version

Type

Description

Quick Code

TRT/File Type

Standard

Format

Frame Rate

Part(s)

Aspect Ratio

Textless

Captioning

Subtitles

Audio

Date Created

Outside BC

Alerts

The database record may include additional information including links to the generated images.

Link to Three Dimensional Element Virtual
Representation
Link to Images Corresponding to Each
Side of Physical element
Comments

The virtual library system may also include virtual library retrieval software. The virtual library retrieval software may be opened 810. The virtual library retrieval software may be opened or initiated because a user or videotape/audiotape library administrator may desire to find a specific videotape/audiotape or multiple videotapes/audiotapes based on a request by a film director, producer or production manager. The virtual library retrieval software application may receive 815 element selection input identifying an element virtual representation (or multiple element virtual representations) that is or are to be retrieved by the virtual library retrieval software. For example, the virtual library retrieval software may receive a request to locate the element virtual representation for a videotape from December of 2009 including footage of a train accident or the request may be for the original movie reel footage of a movie title that a studio is about to convert to 3-D.

The virtual library retrieval software may then retrieve 820 the element virtual representation that matches (or is most closely aligned with) the element selection input. Under certain operation conditions, the virtual vault retrieval software may retrieve multiple element virtual representation and present a list of the multiple element virtual representations to be retrieved. An administrator or user may then select one of the multiple element virtual representations for viewing or displaying.

The virtual vault retrieval software may display 825 the selected or retrieved element virtual representation. In certain operating environments, the virtual vault retrieval software may also present a number of element virtual representations that most closely are aligned with the element selection input (for example, if no exact match is found). In these operating environments, multiple virtual representations are actually displayed on a single screen but only one may be active at a single time.

The virtual vault retrieval system may receive input from a user to manipulate the selected element virtual representation and may manipulate the display 830 of the element virtual representation based on the requested input. For example, the virtual vault retrieval system may turn, flip, zoom or rotate the selected element virtual representation. Thus, the virtual vault retrieval system may zoom to have a magnified view of one of the faces of the element virtual representation. This is one of the important aspects of the invention because the user or administrator (or the producer or director) may recognize visual characteristics (i.e., writing on a label, a specific code on the label, a figure on the label, a marking on the physical element, etc.) of the original physical element in the displayed element virtual representation. Thus, it is imperative to be able to see all views of the displayed element virtual representation and also be able to zoom in on labels or faces of the element virtual representation in order to be able read and/or recognize the visual characteristics of the original physical element.

Under certain operating conditions, the virtual library retrieval system may receive input to display 835 the interior of the element virtual representation and the virtual library retrieval system may display an interior of the element virtual representation based on the input. The user may then view an interior image of the selected element virtual representation. The virtual vault retrieval system may also receive 840 input to manipulate the interior display of the element virtual representation. Illustratively, the virtual vault system may rotate or zoom a view of the interior of the selected element virtual representation.

The invention may be implemented in software. In another embodiment of the invention, some or all aspects of the invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions. Thus, the invention may be implemented in one or more computer programs executing on one or more programmable computer systems each comprising at least one processor, at least one data storage system (which may include volatile and non-volatile memory and/or storage elements), at least one input device or port, and at least one output device or port. In an embodiment of the invention, a computing device may include a storage medium, memory and a processor. The virtual library software may be stored on the storage medium and may include instructions. The virtual vault software application may be opened or initiated and the instructions may be loaded into memory and executed by the processor of the computing device. The computing device, through a communication interface (IDE, USB, wireless protocol or wired protocol), may transmit instructions to external devices such as a display or monitor, an image capture device, or an illumination device. The computing device may also receive images or other information from external sources via the communication interface.

The invention may be implemented using the client-server model. Client software may be installed on multiple machines in a facility and the workstations may be coupled to a central or remote server. The application program or a significant portion of the program may reside on the server. A database may house relevant data for the application and a database engine may control access to the data. The invention may be implemented on a PC system where the application program resides on the PC System. In either of these cases, the virtual library system software may be installed on one single machine along with the database. In other operating embodiments, the virtual library system software modules (i.e., virtual library image capture software and virtual library retrieval software) may be installed on separate computing devices and the database may be on a separate computing device (or co-located with one of the computing devices having the other virtual library system software module stored thereon.

Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein. The computer program or the computer application is stored in a storage media of the computing device. In order to initiate the software, the software (and instructions within the software) is loaded into a memory and a processor executes the instructions in order to initiate and run the software.

1. A computer implemented method, the computer having a memory and a processor, the memory receiving instructions, which when executed by the processor cause the computing device to:
receive a virtual representation model including scale dimensions of the virtual representation model;
transmitting instructions to cause a plurality of image capture devices to capture a plurality of images of sides of a physical element;
transmitting instructions to cause on the plurality of image capture devices to capture an image of an interior of the physical element;
receive the plurality of images captured by the image capture devices, including the image of the interior of the physical element, and store the generated images in a memory of the computing device; and
crop each received image to correspond to a scale dimension for one of the sides side of the virtual representation model to create a plurality of cropped images.

2. The computer implemented method of claim 1, the memory receiving instructions, which when executed by the processor cause the computing device to:
map the plurality of cropped images to create an element virtual representation.

3. The computer implemented method of claim 1, the memory receiving instructions, which when executed by the processor cause the computing device to generate instructions to scan the plurality of images captured by the image capture device to generate metadata for each captured image.

4. The computer implemented method of claim 1, the memory receiving instructions, which when executed by the processor cause the computing device to store the captured metadata in a database and index the captured metadata to be associated with the captured images.

5. A computer implemented method, the computer having a memory and a processor, the memory receiving instructions, which when executed by the processor cause the computing device to:
receive element selection input identifying characteristics of a requested element virtual representation;
retrieve an element virtual representation matching the element selection input; and
display the retrieved element virtual representation.

6. The computer implemented method of claim 5, the computer having a memory and a processor, the memory receiving instructions, which when executed by the processor cause the computing device to:
receive display characteristic input and manipulate element virtual representation based on the received display characteristic.

7. The computer implemented method of claim 6, the memory receiving instructions, which when executed by the processor cause the computing device to:
receive interior viewing input and manipulate element virtual representation based on received interior viewing input.
